(19) United States
(12) Patent Application Publication
(10) Pub. No.: US 2020/0126035 A1
(43) Pub. Date: Apr. 23, 2020

(54) RECOMMENDATION METHOD AND APPARATUS, ELECTRONIC DEVICE, AND COMPUTER STORAGE MEDIUM

(71) Applicant: BEIJING XIAODU INFORMATION TECHNOLOGY CO., LTD., Beijing (CN)

(72) Inventor: Chun ZENG, BEIJING (CN)

(21) Appl. No.: 16/663,305

(22) Filed: Oct. 24, 2019

Related U.S. Application Data
(63) Continuation of application No. PCT/CN2017/118777, filed on Dec. 26, 2017.

(30) Foreign Application Priority Data
Apr. 26, 2017 (CN) 201710282964.3

(51) Int. Cl. G06Q 10/08; G06N 5/04

(52) U.S. Cl. CPC G06Q 10/0834; G06N 20/00; G06N 5/04

(57) ABSTRACT

A recommendation method and apparatus, an electronic device, and a computer storage medium are provided. The recommendation method includes: determining at least one candidate supplier based on a to-be-recommended user; obtaining an adjusted evaluation value of at least one user corresponding to each of the at least one candidate supplier, where the adjusted evaluation value is obtained by adjusting an initial evaluation value based on a time-dependent characteristic in a recommendation scenario; and recommending a supplier to the to-be-recommended user based on the adjusted evaluation value of the at least one user corresponding to each of the at least one candidate supplier. In accordance with the embodiments of this disclosure, the effectiveness of the recommendation is improved.

### CROSS-REFERENCE To RELATED APPLICATION

This application is a continuation application of International Patent Application No. PCT/CN2017/118777, filed on Dec. 26, 2017, which is based on and claims priority to the Chinese Patent Application No. 201710282964.3, filed on Apr. 26, 2017 and entitled “RECOMMENDATION METHOD AND APPARATUS.” The above-referenced applications are incorporated herein by reference in their entirety.

### TECHNICAL FIELD

This disclosure relates generally to the field of Internet technologies, and more specifically, to a recommendation method and apparatus, an electronic device, and a computer storage medium.

### BACKGROUND

With development of Internet technologies, personalized recommendation services have been widely used in the Internet industry including, for example, searching for nearby services on a map, searching for nearby restaurants on a take-out application, and the like. To recommend content of interests such as a service or a restaurant to a user, in addition to geographical location, behavior data such as browsed information, historical orders, and commodity evaluations may be collected and analyzed to determine interests of the user, and recommendations are then provided based on the interests of the user.

A common recommendation method based on a user's interests in the related art mainly includes content-based recommendation method and collaborative filtering recommendation method. The related recommendation methods may result in failure to provide recommendations or providing imprecise recommendations.

### SUMMARY

The existing content-based recommendation method and collaborative filtering recommendation method have been analyzed.

Basic principle of the content-based recommendation method is mainly to use technologies such as natural language processing, artificial intelligence, probability statistics, and machine learning to perform content filtering to discover interests of a user, and to recommend to the user commodities similar to those previously preferred by the user.

Basic principle of the collaborative filtering recommendation method is mainly to analyze interests of a user, find users similar to the user from a user group, and determine the preference of the user for information based on evaluations of such information by these similar users, and to provide recommendations for the user based on such preference.

The foregoing recommendation methods have good performance, but the issue of failure to provide recommendations or providing imprecise recommendations still exists.

In view of the aforementioned limitations, research and analysis have been performed to find that while factors such as geographical location, interests of the user, user behavior, and the like have been considered in the foregoing recommendation methods, impact of time on the user behavior has been ignored. For example, a user may expect to have dinner that is different from lunch, to order food that is different from what was ordered yesterday, and eat differently on weekdays and weekends. Therefore, it might be inappropriate to use the existing recommendation methods to recommend to the user food previously preferred by the user or food that has been ordered by the user. Conversely, to ensure diversified diet of the user, food that has not been ordered recently should be recommended to the user. In addition, as time elapses, food that has been previously ordered may become appealing to the user again. Therefore, it is also appropriate to regularly recommend commodities similar to those previously ordered.

Based on the foregoing analysis, this disclosure provides a recommendation method. In this recommendation method, a time factor is considered in the recommendation process, an initial evaluation value of a user for a commodity is adjusted based on a time-dependent characteristic in a recommendation scenario, and a recommendation is further provided based on the adjusted evaluation value. By considering the time factor in the recommendation process, the effectiveness of the recommendation may be improved.

One aspect of this disclosure is directed to a recommendation method. The recommendation method may include: determining at least one candidate supplier based on a to-be-recommended user; obtaining an adjusted evaluation value of at least one user corresponding to each of the at least one candidate supplier, wherein the adjusted evaluation value is obtained by adjusting an initial evaluation value based on a time-dependent characteristic in a recommendation scenario, and wherein the time-dependent characteristic in the recommendation scenario is a characteristic that positive impact of a time factor on a recommendation process increases with time; and recommending a supplier to the to-be-recommended user based on the adjusted evaluation value of the at least one user corresponding to each of the at least one candidate supplier.

In the aforementioned method, obtaining an adjusted evaluation value of at least one user corresponding to each of the at least one candidate supplier may include: multiplying each commodity evaluation value sequence in a first user-supplier initial evaluation matrix by a corresponding time adjustment factor sequence to pre-construct a user-supplier adjusted-evaluation matrix, wherein, in each commodity evaluation value sequence, a time adjustment factor corresponding to a commodity evaluation value is a ratio of an absolute time difference between a current time and a network behavior occurrence time corresponding to the evaluation value to a time period in the recommendation scenario; and obtaining, from the pre-constructed user-supplier adjusted-evaluation matrix, the adjusted evaluation value of the at least one user corresponding to each of the at least one candidate supplier.

In some embodiments of this disclosure, the user-supplier adjusted-evaluation matrix includes an adjusted evaluation value of at least one user corresponding to each of a plurality of suppliers in a system, and the plurality of suppliers include the at least one candidate supplier.

In some embodiments of this disclosure, pre-constructing the user-supplier adjusted-evaluation matrix may include: construing a first user-commodity evaluation matrix based on information about network behavior in the system performed by a user on a commodity; performing dimension conversion on the first user-commodity evaluation matrix to obtain a first user-supplier initial evaluation matrix, where the first user-supplier initial evaluation matrix includes a commodity evaluation value sequence of the at least one user corresponding to each of the plurality of suppliers; and multiplying each commodity evaluation value sequence in the first user-supplier initial evaluation matrix by the corresponding time adjustment factor sequence to pre-construct the user-supplier adjusted-evaluation matrix.

In some embodiments of this disclosure, for a commodity evaluation value sequence <vₐᵢ_{₁}, vₐᵢ_{₂}, . . . , vₐᵢ_{ₙ}> of a user Uₐ corresponding to a supplier Sₖ in the first user-supplier initial evaluation matrix, a network behavior occurrence time sequence corresponding to the commodity evaluation value sequence <vₐᵢ_{₁}, vₐᵢ_{₂}, . . . , vₐᵢ_{ₙ}> may be <tᵢ_{₁}, tᵢ_{₂}, . . . , tᵢ_{ₙ}>. The calculating a time adjustment factor sequence <δₐᵢ_{₁}, δₐᵢ_{₂}, . . . , δₐᵢ_{ₙ}> corresponding to each commodity evaluation value sequence <vₐᵢ_{₁}, vₐᵢ_{₂}, . . . , vₐᵢ_{ₙ}> in the first user-supplier initial evaluation matrix based on the time-dependent characteristic in the recommendation scenario and a network behavior occurrence time sequence <tᵢ_{₁}, tᵢ_{₂}, . . . , tᵢ_{ₙ}> corresponding to each commodity evaluation value sequence in the first user-supplier initial evaluation matrix may include: calculating time adjustment factors in the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> based on a formula

$${δ}_{{ai}_{j}} = \frac{\vert {T}_{ow} - {t}_{{i}_{j}} \vert}{{T}_{period}} .$$

δₐᵢ_{ⱼ} may represent a time adjustment factor corresponding to an evaluation value vₐᵢ_{ⱼ} in the commodity evaluation value sequence <vₐᵢ_{₁}, vₐᵢ_{₂}, . . . , vₐᵢ_{ₙ}>, 1≤j≤n, and j and n may be natural numbers. T_{now} may represent a current time, T_{period} may represent a time period in the recommendation scenario, and tᵢ_{ⱼ} may represent a network behavior occurrence time corresponding to the evaluation value vₐᵢ_{ⱼ}.

In some embodiments of this disclosure, the commodity evaluation value sequence <vₐᵢ_{₁}, vₐᵢ_{₂}, . . . , vₐᵢ_{ₙ}> may be multiplied by the time adjustment factor sequence <δₐᵢ_{₁},δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}>, to obtain an adjusted evaluation value of the user Uₐ corresponding to the supplier Sₖ in the user-supplier adjusted-evaluation matrix. This step may include: calculating the adjusted evaluation value of the user Uₐ corresponding to the supplier Sₖ based on a formula

$${V}_{ak}^{′} = {\sum }_{j = 1}^{n} {δ}_{{ai}_{j}} {v}_{{ai}_{j}} .$$

v′ₐₖ may represents the adjusted evaluation value of the user Uₐ corresponding to the supplier Sₖ.

In some embodiments of this disclosure, the obtaining an adjusted evaluation value of at least one user corresponding to each of the at least one candidate supplier may include: constructing a second user-commodity evaluation matrix based on information about network behavior in a system performed by a user on a commodity provided by the at least one candidate supplier; performing dimension conversion on the second user-commodity evaluation matrix to obtain a second user-supplier initial evaluation matrix, where the second user-supplier initial evaluation matrix includes a commodity evaluation value sequence of the at least one user corresponding to each of the at least one candidate supplier; and adjusting the second user-supplier initial evaluation matrix based on the time-dependent characteristic in the recommendation scenario, to obtain a user-candidate supplier adjusted-evaluation matrix, where the user-candidate supplier adjusted-evaluation matrix includes the adjusted evaluation value of the at least one user corresponding to each of the at least one candidate supplier.

In some embodiments of this disclosure, the recommending a supplier to the to-be-recommended user based on the adjusted evaluation value of the at least one user corresponding to each of the at least one candidate supplier may include: recommending a supplier to the to-be-recommended user by using a user-based collaborative filtering algorithm based on the adjusted evaluation value of the at least one user corresponding to each of the at least one candidate supplier; or recommending a supplier to the to-be-recommended user by using a supplier-based collaborative filtering algorithm based on the adjusted evaluation value of the at least one user corresponding to each of the at least one candidate supplier.

In some embodiments of this disclosure, the determining at least one candidate supplier based on a to-be-recommended user may include: obtaining the at least one candidate supplier from a supplier set based on a location of the to-be-recommended user.

Another aspect of this disclosure is directed to a recommendation apparatus. The apparatus may include: a determining module, an obtaining module, a recommendation module, and a construction module. The determining module may be configured to determine at least one candidate supplier based on a to-be-recommended user. The obtaining module may be configured to obtain an adjusted evaluation value of at least one user corresponding to each of the at least one candidate supplier, and the adjusted evaluation value may be obtained by adjusting an initial evaluation value based on a time-dependent characteristic in a recommendation scenario. The time-dependent characteristic in the recommendation scenario may be a characteristic that positive impact of a time factor on a recommendation process increases with time. The recommendation module may be configured to recommend a supplier to the to-be-recommended user based on the adjusted evaluation value of the at least one user corresponding to each of the at least one candidate supplier. The construction module may be configured to multiply each commodity evaluation value sequence in a first user-supplier initial evaluation matrix by a corresponding time adjustment factor sequence to pre-construct a user-supplier adjusted-evaluation matrix. In each commodity evaluation value sequence, a time adjustment factor corresponding to a commodity evaluation value may be a ratio of an absolute time difference between a current time and a network behavior occurrence time corresponding to the evaluation value to a time period in the recommendation scenario. The obtaining module may be specifically configured to obtain, from the pre-constructed user-supplier adjusted-evaluation matrix, the adjusted evaluation value of the at least one user corresponding to each of the at least one candidate supplier.

In some embodiments of this disclosure, the user-supplier adjusted-evaluation matrix may include an adjusted evaluation value of at least one user corresponding to each of a plurality of suppliers in a system, and the plurality of suppliers may include the at least one candidate supplier.

In some embodiments of this disclosure, the construction module may include a construction submodule, a dimension conversion submodule, and an adjustment submodule.

The construction submodule may be configured to construct a first user-commodity evaluation matrix based on information about network behavior in the system performed by a user on a commodity. The dimension conversion submodule may be configured to perform dimension conversion on the first user-commodity evaluation matrix to obtain a first user-supplier initial evaluation matrix. The first user-supplier initial evaluation matrix may include a commodity evaluation value sequence of the at least one user corresponding to each of the plurality of suppliers. The adjustment submodule may be configured to multiply each commodity evaluation value sequence in the first user-supplier initial evaluation matrix by the corresponding time adjustment factor sequence to pre-construct the user-supplier adjusted-evaluation matrix.

In some embodiments of this disclosure, for a commodity evaluation value sequence <vₐᵢ_{₁}, vₐᵢ_{₂}, . . . , vₐᵢ_{ₙ}> of a user Uₐ corresponding to a supplier Sₖ in the first user-supplier initial evaluation matrix, a network behavior occurrence time sequence corresponding to the commodity evaluation value sequence <vₐᵢ_{₁}, vₐᵢ_{₂}, . . . , vₐᵢ_{ₙ}> may be <tᵢ_{₁}, tᵢ_{₂}, . . . vᵢ_{ₙ}>. When calculating a time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> based on the time-dependent characteristic in the recommendation scenario and the network behavior occurrence time sequence <tᵢ_{₁}, tᵢ_{₂}, . . . , tᵢ_{ₙ}>, the adjustment submodule may be specifically configured to: calculate time adjustment factors in the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> based on a formula

$${δ}_{{ai}_{j}} = \frac{\vert {T}_{now} - {t}_{{i}_{j}} \vert}{{T}_{period}} .$$

δₐᵢ_{ⱼ} may represent a time adjustment factor corresponding to an evaluation value vₐᵢ_{ⱼ} in the commodity evaluation value sequence <vₐᵢ_{₁}, vₐᵢ_{₂}, . . . , vₐᵢ_{ₙ}>, 1≤j≤n, and j and n may be natural numbers. T_{now} may represent a current time, T_{period} may represent a time period in the recommendation scenario, and tᵢ_{ⱼ} may represent a network behavior occurrence time corresponding to the evaluation value vₐᵢ_{ⱼ}.

In some embodiments of this disclosure, when multiplying the commodity evaluation value sequence <vₐᵢ_{₁}, vₐᵢ_{₂}, . . . , vₐᵢ_{ₙ}> by the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}>, to obtain an adjusted evaluation value of the user Uₐ corresponding to the supplier Sₖ in the user-supplier adjusted-evaluation matrix, the adjustment submodule may be specifically configured to: calculate the adjusted evaluation value of the user Uₐ corresponding to the supplier Sₖ based on a formula

$${V}_{ak}^{′} = {\sum }_{j = 1}^{n} {δ}_{{ai}_{j}} {v}_{{ai}_{j}} .$$

v′ₐₖ may represent the adjusted evaluation value of the user Uₐ corresponding to the supplier Sₖ.

In some embodiments of this disclosure, the obtaining module may be specifically configured to: construct a second user-commodity evaluation matrix based on information about network behavior in a system performed by a user on a commodity provided by the at least one candidate supplier; perform dimension conversion on the second user-commodity evaluation matrix to obtain a second user-supplier initial evaluation matrix, where the second user-supplier initial evaluation matrix includes a commodity evaluation value sequence of the at least one user corresponding to each of the at least one candidate supplier; and adjust the second user-supplier initial evaluation matrix based on the time-dependent characteristic in the recommendation scenario, to obtain a user-candidate supplier adjusted-evaluation matrix, where the user-candidate supplier adjusted-evaluation matrix includes the adjusted evaluation value of the at least one user corresponding to each of the at least one candidate supplier.

In some embodiments of this disclosure, the recommendation module may be specifically configured to: recommend a supplier to the to-be-recommended user by using a user-based collaborative filtering algorithm based on the adjusted evaluation value of the at least one user corresponding to each of the at least one candidate supplier; or recommend a supplier to the to-be-recommended user by using a supplier-based collaborative filtering algorithm based on the adjusted evaluation value of the at least one user corresponding to each of the at least one candidate supplier.

In some embodiments of this disclosure, the determining module may be specifically configured to obtain the at least one candidate supplier from a supplier set based on a location of the to-be-recommended user.

Another aspect of this disclosure is directed to an electronic device. The electronic device may include a memory and a processor. The memory may be configured to store one or more computer instructions, and the one or more computer instructions may be executed by the processor to perform the recommendation method provided in the any of the foregoing embodiments.

Another aspect of this disclosure is directed to a computer readable storage medium storing a computer program. The computer program may enable a computer to perform the recommendation method provided in any of the foregoing embodiments.

In the embodiments of this disclosure, the time factor is considered in the recommendation process, the initial evaluation value of the user for the commodity is adjusted based on the time-dependent characteristic in the recommendation scenario, and a recommendation is further provided based on the adjusted evaluation value. By considering the time factor in the recommendation process, the effectiveness of the recommendation may be further improved.

### BRIEF DESCRIPTION OF THE DRAWINGS

The accompanying drawings described herein are intended to provide a further understanding of this disclosure, and constitute a part of this disclosure. The illustrative embodiments of this disclosure and descriptions thereof are intended to describe this disclosure, and do not constitute limitations on this disclosure.

FIG. 1 is a schematic flowchart of a recommendation method according to an embodiment of this disclosure.

FIG. 2a is a schematic flowchart of a recommendation method according to another embodiment of this disclosure.

FIG. 2b is a schematic diagram of an implementation of a user-supplier adjusted-evaluation matrix according to another embodiment of this disclosure.

FIG. 2c is a schematic diagram of another implementation of a user-supplier adjusted-evaluation matrix according to another embodiment of this disclosure.

FIG. 3a is a schematic flowchart of pre-constructing a user-supplier adjusted-evaluation matrix according to still another embodiment of this disclosure.

FIG. 3b is a schematic diagram of an implementation of a first user-commodity evaluation matrix according to still another embodiment of this disclosure.

FIG. 3c is a schematic diagram of another implementation of a first user-commodity evaluation matrix according to still another embodiment of this disclosure.

FIG. 3d is a schematic diagram of a process in which a first user-commodity evaluation matrix is converted from a user-commodity dimension to a user-supplier dimension according to still another embodiment of this disclosure.

FIG. 4 is a schematic flowchart of a recommendation method according to still another embodiment of this disclosure.

FIG. 5 is a schematic flowchart of a recommendation method according to still another embodiment of this disclosure.

FIG. 6 is a schematic flowchart of a recommendation method according to still another embodiment of this disclosure.

FIG. 7 is a schematic structural diagram of a recommendation apparatus according to still another embodiment of this disclosure.

FIG. 8 is a schematic structural diagram of a recommendation apparatus according to still another embodiment of this disclosure.

FIG. 9 is a schematic structural diagram of an electronic device that performs a recommendation method provided in the embodiments of this disclosure according to still another embodiment of this disclosure.

### DETAIL DESCRIPTION OF THE EMBODIMENTS

To make the objectives, technical solutions, and advantages of this disclosure clearer, the following clearly and completely describes the technical solutions of this disclosure with reference to the specific embodiments of this disclosure and the corresponding accompanying drawings. Apparently, the described embodiments are merely some but not all of the embodiments of this disclosure. All other embodiments obtained by a person of ordinary skill in the art based on the embodiments of this disclosure without creative efforts shall fall within the protection scope of this disclosure.

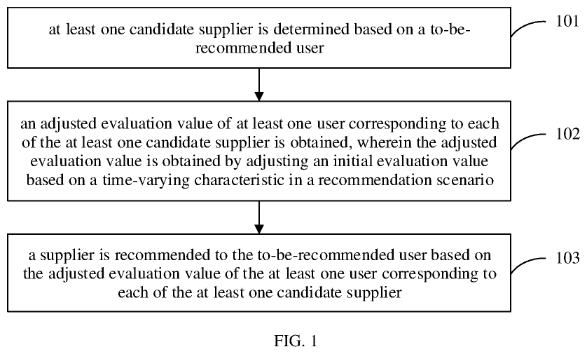

FIG. 1 is a schematic flowchart of a recommendation method according to an embodiment of this disclosure. As shown in FIG. 1, the method includes the following steps 101 to 103.

In step 101, at least one candidate supplier is determined based on a to-be-recommended user.

In step 102, an adjusted evaluation value of at least one user corresponding to each of the at least one candidate supplier is obtained. The adjusted evaluation value may be obtained by adjusting an initial evaluation value based on a time-dependent characteristic in a recommendation scenario.

In step 103, a supplier may be recommended to the to-be-recommended user based on the adjusted evaluation value of the at least one user corresponding to each of the at least one candidate supplier.

In a mobile Internet application (Application, App), related content often needs to be recommended to a user for various reasons. For ease of description, in this embodiment of this disclosure, a user who needs to be recommended for contents may be referred to as a “to-be-recommended user”. Content that needs to be recommended to a user may vary with an application scenario. The embodiments of this disclosure are mainly applicable to an application scenario in which there are a large quantity of suppliers, so that one supplier may be recommended to a user to help the user purchase a commodity from the suitable supplier. For example, the recommendation method provided in this embodiment of this disclosure may be applicable to shopping Apps or take-out order Apps provided by various on-line retailers.

Referring to step 101, in a recommendation process, the to-be-recommended user may be first determined, and the at least one candidate supplier may be determined based on the to-be-recommended user. The to-be-recommended user may be any user such as, for example, a regular user, a new user, or a potential user of a mobile Internet App.

Optionally, all suppliers in a supplier set may be used as candidate suppliers. Determining a candidate supplier in this way is simple and efficient. In addition, a quantity of the determined candidate suppliers may be relatively large, providing a relatively comprehensive coverage, so that a suitable supplier may be recommended to the user.

Optionally, the at least one candidate supplier may be obtained from a supplier set based on a location of the to-be-recommended user. For example, it may be required that only suppliers that are near the to-be-recommended user may be selected, so that a quantity of candidate suppliers may be reduced. Thus the calculation workload may be reduced, the computing resources may be saved and overall effectiveness of recommendation may be improved.

For example, at least one supplier within a specified area of the to-be-recommended user may be selected from the supplier set as a candidate supplier based on the location of the to-be-recommended user. Alternatively, at least one supplier within a specified distance from the to-be-recommended user may be selected from the supplier set as a candidate supplier based on the location of the to-be-recommended user.

In an actual application process, to improve service quality and user experience, a supplier may allow a user to evaluate the supplier and/or a commodity provided by the supplier. After purchasing a commodity from a supplier, or using or consuming a commodity, a user usually may evaluate the supplier and/or the commodity provided by the supplier. The evaluation done by a user for a supplier or a commodity provided by a supplier may vary with an application scenario. For example, in a shopping application scenario or a take-out order application scenario, star icons may be provided, from which a user may select corresponding star icons to score a supplier or a commodity provided by a supplier. For example, the user may give five stars or three stars to a supplier or a commodity provided by a supplier. In addition, a text input box may be provided to allow the user to enter a text comment to evaluate the supplier or the commodity provided by the supplier.

Based on the foregoing content, an initial evaluation value of the user for the supplier may be determined by comprehensively considering the star icons selected by the user and the text comment provided by the user. In other words, the initial evaluation value of the user for the candidate supplier may be reflected by using an evaluation made by the user on the candidate supplier and/or a commodity provided by the candidate supplier.

In the prior art, after obtaining initial evaluation values of a user for candidate suppliers, a supplier may usually be recommended to the user from the candidate suppliers based on the initial evaluation values of the user for the candidate suppliers. In this embodiment, a time factor is considered in the recommendation process. The initial evaluation value may be adjusted based on the time-dependent characteristic applicable to the recommendation scenario, and the supplier is recommended to the user based on the adjusted evaluation value.

Referring to step 102, the adjusted evaluation value of the at least one user corresponding to each of the at least one candidate supplier may be obtained, and the adjusted evaluation value may be obtained by adjusting the initial evaluation value based on the time-dependent characteristic in the recommendation scenario.

For any one of the at least one candidate supplier, at least one user may purchase or consume a commodity from the candidate supplier. In this case, at least one user who purchases a commodity from the candidate supplier and makes an evaluation may be determined. Then, an adjusted evaluation value of each of the at least one user for the candidate supplier may be obtained. From a perspective of the candidate supplier, the adjusted evaluation value of the at least one user corresponding to the candidate supplier may be an adjusted evaluation value for the candidate supplier from at least one user who makes an evaluation on the candidate supplier and/or a commodity provided by the candidate supplier.

An adjusted evaluation value of a user for a candidate supplier is obtained by adjusting an initial evaluation value of the user for the candidate supplier based on the time-dependent characteristic applicable to the recommendation scenario. The initial evaluation value of the user for the candidate supplier may be reflected by an evaluation made by the user on the candidate supplier and/or a commodity provided by the candidate supplier. For example, the initial evaluation value of the user for the candidate supplier may be directly represented as an evaluation value of the user for at least one commodity provided by the candidate supplier, or may be represented as a value processing result of an evaluation value of the user for at least one commodity provided by the candidate supplier, or may be directly represented as an evaluation value of the user for the candidate supplier.

The impact of the time factor may vary with a recommendation scenario. For example, in some recommendation scenarios, impact of the time factor on the recommendation process may gradually decrease as time elapses. For example, in some other recommendation scenarios, the impact of the time factor on the recommendation process may gradually increase as time elapses. For another example, in some other recommendation scenarios, the impact of the time factor on the recommendation process may first decrease and then increase as time elapses, or first increase and then decrease as time elapses.

It should be noted that for different candidate suppliers, users who make an evaluation on the candidate suppliers or commodities provided by the candidate suppliers may be the same or different.

Referring to step 103, the supplier may be recommended to the to-be-recommended user based on the adjusted evaluation value of the at least one user corresponding to each of the at least one candidate supplier.

A recommendation method that may be used to recommend a supplier to the to-be-recommended user is not limited in this embodiment. Any suitable method that can be used to recommend a supplier to the to-be-recommended user and that is based on the adjusted evaluation value of the at least one user corresponding to each of the at least one candidate supplier may be applicable to this embodiment of this disclosure.

The impact of the time factor may be considered in the recommendation process of this embodiment, the initial evaluation value of the user for the supplier may be adjusted based on the time-dependent characteristic applicable to the recommendation scenario, and a recommendation may be provided based on the adjusted evaluation value. By considering the time factor in the recommendation process, the effectiveness of the recommendation may be improved.

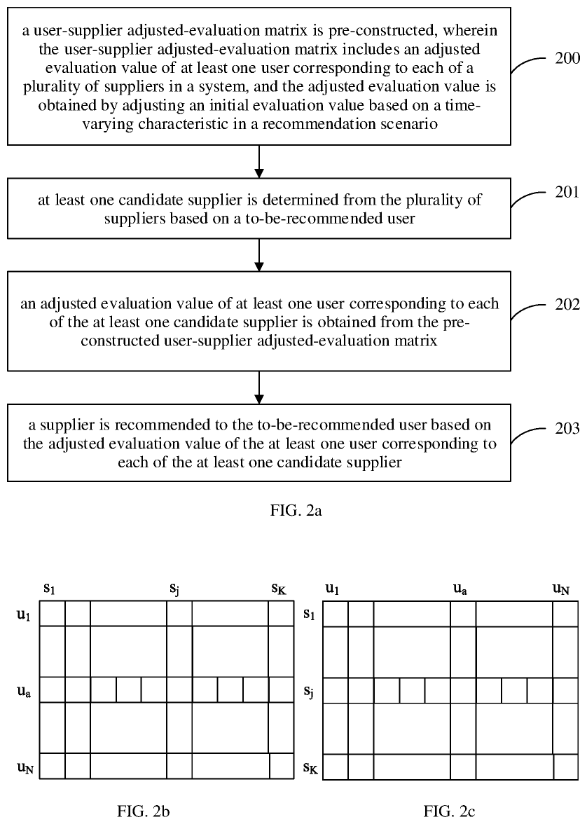

FIG. 2a is a schematic flowchart of a recommendation method according to another embodiment of this disclosure. As shown in FIG. 2a, the method includes the following steps.

In step 200, a user-supplier adjusted-evaluation matrix may be pre-constructed. The user-supplier adjusted-evaluation matrix may include an adjusted evaluation value of at least one user corresponding to each of a plurality of suppliers in a system, and the adjusted evaluation value may be obtained by adjusting an initial evaluation value based on a time-dependent characteristic applicable to a recommendation scenario.

In step 201, at least one candidate supplier may be determined from the plurality of suppliers based on a to-be-recommended user.

In step 202, an adjusted evaluation value of at least one user corresponding to each of the at least one candidate supplier may be obtained from the pre-constructed user-supplier adjusted-evaluation matrix.

In step 203, a supplier may be recommended to the to-be-recommended user based on the adjusted evaluation value of the at least one user corresponding to each of the at least one candidate supplier.

In this embodiment, before a recommendation is provided, the user-supplier adjusted-evaluation matrix may be pre-constructed, as described in step 200, to provide a basis for a recommendation process. The user-supplier adjusted-evaluation matrix may include the adjusted evaluation value of the at least one user corresponding to each of the plurality of suppliers in the system. For any one of the plurality of suppliers, the adjusted evaluation value of the at least one user corresponding to the supplier may be an adjusted evaluation value for the supplier of at least one user who makes an evaluation on the supplier and/or a commodity provided by the supplier.

An adjusted evaluation value of a user for a candidate supplier may be obtained by adjusting an initial evaluation value of the user for the candidate supplier based on the time-dependent characteristic applicable to the recommendation scenario. The initial evaluation value of the user for the candidate supplier may be reflected by an evaluation made by the user on the candidate supplier and/or a commodity provided by the candidate supplier. For example, the initial evaluation value of the user for the candidate supplier may be directly represented as an evaluation value of the user for at least one commodity provided by the candidate supplier, or may be represented as a value processing result of an evaluation value of the user for at least one commodity provided by the candidate supplier, or may be directly represented as an evaluation value of the user for the candidate supplier.

The system may be an application system including the plurality of suppliers. In this embodiment, the application system may include a server, a client on a supplier side, and a client on a user side. The plurality of suppliers may be all suppliers in the application system, or may be some suppliers in the application system.

In the recommendation process, the supplier may be recommended to the to-be-recommended user based on the pre-constructed user-supplier adjusted-evaluation matrix as described in steps 201 to 203.

In step 201, the to-be-recommended user may first be determined, and the at least one candidate supplier may be determined based on a to-be-recommended user from the plurality of suppliers included in the user-supplier adjusted-evaluation matrix. In other words, the plurality of suppliers may include the at least one candidate supplier. The to-be-recommended user may be any user, for example, a regular user, a new user, or a potential user of a mobile Internet App.

Optionally, all suppliers in the plurality of suppliers may be used as candidate suppliers. Determining a candidate supplier in this way is simple and efficient. In addition, a quantity of the determined candidate suppliers is relatively large, providing a relatively comprehensive coverage, so that a suitable supplier may be recommended to the user.

Optionally, the at least one candidate supplier may be obtained from the plurality of suppliers based on a location of the to-be-recommended user. For example, it may be required that only suppliers near the to-be-recommended user may be selected, so that a quantity of candidate suppliers may be reduced. Thus the calculation workload may be reduced, computing resources may be saved, and overall effectiveness of recommendation may be improved.

In step 202, following step 201, the adjusted evaluation value of the at least one user corresponding to each of the at least one candidate supplier may be obtained from the pre-constructed user-supplier adjusted-evaluation matrix.

Optionally, FIG. 2b shows an implementation of a user-supplier adjusted-evaluation matrix. As shown in FIG. 2b, the user-supplier adjusted-evaluation matrix may include a user identifier, a supplier identifier, and an adjusted evaluation value. The user identifier may form a row in the user-supplier adjusted-evaluation matrix, the supplier identifier may form a column in the user-supplier adjusted-evaluation matrix, and the adjusted evaluation value may be an element value in the user-supplier adjusted-evaluation matrix.

Optionally, FIG. 2c shows another implementation of a user-supplier adjusted-evaluation matrix. As shown in FIG. 2c, the user-supplier adjusted-evaluation matrix may include a user identifier, a supplier identifier, and an adjusted evaluation value. The user identifier may form a column in the user-supplier adjusted-evaluation matrix, the supplier identifier may form a row in the user-supplier adjusted-evaluation matrix, and the adjusted evaluation value may be an element value in the user-supplier adjusted-evaluation matrix.

In FIG. 2b or FIG. 2c, a user set may be denoted as U, and a user uₐ may belong to the user set, that is, uₐ∈U={u₁, u₂, . . . , and u_{N}}, where N indicates a quantity of users. A supplier set may be denoted as S, and a commodity sⱼ may belong to the supplier set, that is, sⱼ∈S={s₁, s₂, . . . , and s_{K}}, where K indicates a quantity of suppliers.

The foregoing supplier identifier may be any information that can be used to uniquely identify a supplier, such as a supplier name or a supplier ID. Correspondingly, the foregoing user identifier may be any information that can be used to uniquely identify a user, such as a user name or a user ID. The adjusted evaluation value may be a specific numerical value, such as 5, 3, or 1, or the adjusted evaluation value may be some non-numerical information, such as a gold supplier, a silver supplier, a better reputation, a five-star service, a three-star service, or any other information that can be used for differentiation.

Based on the user-supplier adjusted-evaluation matrix shown in FIG. 2b or FIG. 2c, an identifier of each candidate supplier in the at least one candidate supplier may be used to find a match in the user-supplier adjusted-evaluation matrix to obtain, as an identifier of a user corresponding to the candidate supplier, a user identifier corresponding to a matched supplier identifier. Further, an adjusted evaluation value that is determined by using the matched supplier identifier and the corresponding user identifier may be obtained as an adjusted evaluation value of a user corresponding to each candidate supplier.

In the recommendation process of this embodiment, the adjusted evaluation value of the at least one user corresponding to each candidate supplier may not need to be calculated in real time, but can be directly obtained based on the pre-constructed user-supplier adjusted-evaluation matrix. Thus overall effectiveness of recommendation may be improved.

Referring to step 203, following step 202, the supplier may be recommended to the to-be-recommended user based on the adjusted evaluation value of the at least one user corresponding to each of the at least one candidate supplier.

A recommendation method that can be used to recommend a supplier to the to-be-recommended user is not limited in this embodiment. Any suitable method that can be used to recommend a supplier to the to-be-recommended user and that is based on the adjusted evaluation value of the at least one user corresponding to each of the at least one candidate supplier may be applicable to this embodiment of this disclosure.

In this embodiment, impact of a time factor is considered, and the initial evaluation value of the user for the supplier is adjusted in advance based on the time-dependent characteristic applicable to the recommendation scenario, so that the user-supplier adjusted-evaluation matrix may be constructed. When a recommendation is provided, the adjusted evaluation value of the at least one user corresponding to each candidate supplier may be directly obtained from the user-supplier adjusted-evaluation matrix, achieving relatively high efficiency. Further, a supplier may be recommended based on the adjusted evaluation value of the at least one user corresponding to each candidate supplier. By considering the time factor in the recommendation process, the effectiveness of the recommendation may be improved.

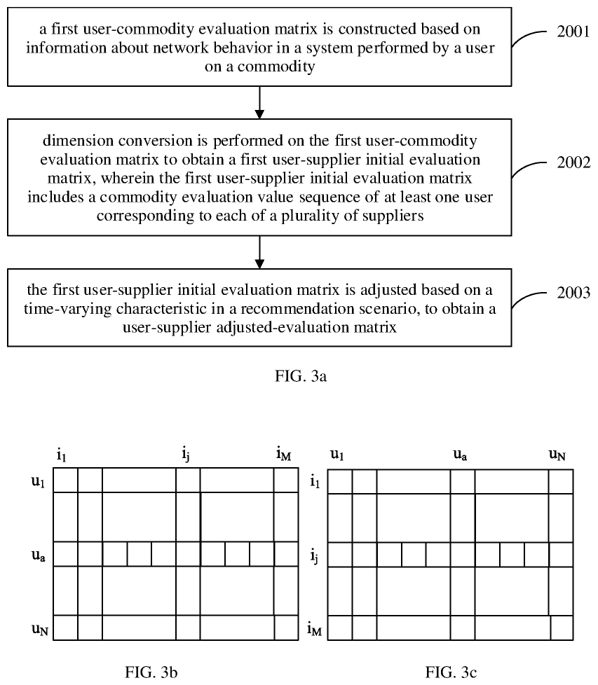

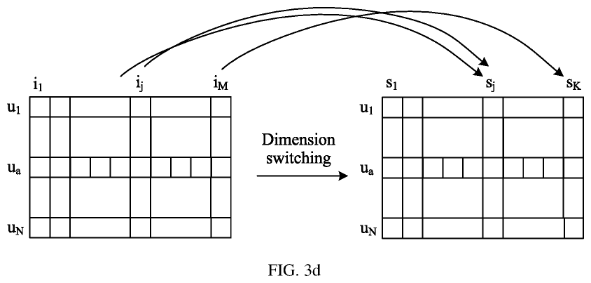

In the foregoing embodiment or the following embodiment, a procedure of pre-constructing a user-supplier adjusted-evaluation matrix is shown in FIG. 3a, and may include the following steps.

In step 2001, a first user-commodity evaluation matrix may be constructed based on information about network behavior in a system performed by a user on a commodity.

The information about the network behavior herein may include evaluation information of the user for the commodity, but is not limited thereto. An evaluation value of the user for the commodity may be obtained based on the evaluation information of the user for the commodity.

FIG. 3b shows an implementation of the first user-commodity evaluation matrix. In FIG. 3b, the first user-commodity evaluation matrix may include a user identifier, a commodity identifier, and an evaluation value of a user for a commodity. The user identifier may be a row in the first user-commodity evaluation matrix, the commodity identifier may be a column in the first user-commodity evaluation matrix, and the evaluation value of the user for the commodity may be an element value in the first user-commodity evaluation matrix.

FIG. 3c shows another implementation of the first user-commodity evaluation matrix. In FIG. 3c, the first user-commodity evaluation matrix may include a user identifier, a commodity identifier, and an evaluation value of a user for a commodity. The user identifier may be a column in the first user-commodity evaluation matrix, the commodity identifier may be a row in the first user-commodity evaluation matrix, and the evaluation value of the user for the commodity may be an element value in the first user-commodity evaluation matrix.

In FIG. 3b or FIG. 3c, a user set may be denoted as U, and a user ua may belong to the user set, that is, uₐ∈U={u₁, u₂, . . . , and u_{N}}, where N indicates a quantity of users. A commodity set may be denoted as I, and a commodity iⱼ may belong to the commodity set, that is, iⱼ∈I={i₁, i₂, . . . , and i_{M}}, where M indicates a quantity of commodities.

In step 2002, dimension conversion may be performed on the first user-commodity evaluation matrix to obtain a first user-supplier initial evaluation matrix. The first user-supplier initial evaluation matrix may include a commodity evaluation value sequence of at least one user corresponding to each of a plurality of suppliers.

In a recommendation method provided in this embodiment of this disclosure, because there are a large collections of commodities, the data for a commodity-based recommendation may be sparse. Therefore, in this embodiment of this disclosure, a commodity is not recommended to a user by using a conventional recommendation method. Instead, evaluations made by a user on commodities may be aggregated, by using a relationship between a commodity and a supplier, into an evaluation made by the user on a supplier, and the supplier may be recommended to the user based on the evaluation made by the user on the supplier.

The relationship between a commodity and a supplier may be expressed as follows. The supplier may provide a commodity for consumption by a user, the supplier may include an attribute of the commodity, and behavior of purchasing or consuming the commodity from the supplier by the user may reflect hidden interests of the user in the supplier. The hidden interests of the user in the supplier may be reflected as a quantity of times of purchasing or consuming commodities from the supplier, an amount of consumption, and an evaluation.

In this embodiment, the first user-commodity evaluation matrix may need to be converted from a user-commodity dimension to a user-supplier dimension. FIG. 3d is a schematic diagram of a dimension conversion process. Optionally, a dimension conversion may be performed as follows. From a perspective of a supplier, commodities belonging to a same supplier are first obtained from the first user-commodity evaluation matrix. The commodities belonging to the same supplier are then distinguished from each other by user, and evaluation values of a same user for different commodities are summarized, to form a commodity evaluation value sequence of the same user, so as to obtain the commodity evaluation value sequence of the at least one user corresponding to each of the plurality of suppliers, namely, the first user-supplier initial evaluation matrix.

In step 2003, the first user-supplier initial evaluation matrix may be adjusted based on a time-dependent characteristic in a recommendation scenario to obtain a user-supplier adjusted-evaluation matrix.

After obtaining the first user-supplier initial evaluation matrix, the first user-supplier initial evaluation matrix may be adjusted based on the time-dependent characteristic applicable to the recommendation scenario, to obtain the user-supplier adjusted-evaluation matrix. The adjustment on the first user-supplier initial evaluation matrix based on the time-dependent characteristic in the recommendation scenario may essentially be a process of adjusting an element value in the first user-supplier initial evaluation matrix based on the time-dependent characteristic in the recommendation scenario.

Optionally, step 2003 may include: calculating a time adjustment factor sequence corresponding to each commodity evaluation value sequence in the first user-supplier initial evaluation matrix based on the time-dependent characteristic in the recommendation scenario and a network behavior occurrence time sequence corresponding to each commodity evaluation value sequence in the first user-supplier initial evaluation matrix; and multiplying each commodity evaluation value sequence in the first user-supplier initial evaluation matrix by the corresponding time adjustment factor sequence to obtain the user-supplier adjusted-evaluation matrix.

In the first user-supplier initial evaluation matrix, each commodity evaluation value sequence may correspond to one user and one supplier. For the user, the user may purchase or consume at least one commodity from the supplier and evaluate the at least one commodity, so that an evaluation value of the user for the at least one commodity may be summarized to obtain a commodity evaluation value sequence of the user corresponding to the supplier. In other words, each commodity evaluation value sequence may include an evaluation value of a user corresponding to the commodity evaluation value sequence for at least one commodity provided by a supplier corresponding to the commodity evaluation value sequence. Correspondingly, one commodity evaluation value sequence may also correspond to one network behavior occurrence time sequence, and the network behavior occurrence time sequence may be a time that the user purchases or consumes the at least one commodity from the supplier.

There is a time sequence for behavior of purchasing or consuming commodities from a supplier by a user. This sequence may reflect, in terms of time, a periodic habit of the user in purchasing or consuming a commodity from the supplier. This periodic habit (i.e., a time factor) may affect a recommendation process.

In a specific recommendation scenario, the time-dependent characteristic may be a characteristic that positive impact of a time factor on a recommendation process increases with time. For example, in a take-out order application scenario, a user may expect to have dinner different from lunch, order food different from yesterday, and order differently at weekends. Therefore, it can be learned that in this scenario, the user usually has no interests in food that has been ordered recently, but as time elapses, the user may gradually become interested in food that has been ordered before. A longer time that has passes since the last time the user ordered the food may indicate a refreshed sense of interests. Therefore, it is necessary to recommend regularly commodities previously ordered, and this may reflect a fact that the positive impact of the time factor on the recommendation process may increase with time.

For example, based on the foregoing content, a user Uₐ in the first user-supplier initial evaluation matrix may make an evaluation on n commodities ordered from a supplier Sₖ, where the n commodities may be represented as <i₁, i₂, . . . , iₙ>. In this case, a commodity evaluation value sequence of the user Uₐ corresponding to the supplier Sₖ in the first user-supplier initial evaluation matrix may be represented as <vₐᵢ_{₁}, vₐᵢ_{₂}, . . . , vₐᵢ_{ₙ}>, and a network behavior occurrence time sequence corresponding to the commodity evaluation value sequence may be represented as <tᵢ_{₁}, tᵢ_{₂}, . . . , tᵢ_{ₙ}>. More specifically, the user Uₐ may order a commodity i₁ from the supplier Sₖ at a moment tᵢ_{₁}, and generate an evaluation value vₐᵢ_{₁} for the commodity i₁. Correspondingly, the user Uₐ may order a commodity i₂ from the supplier Sₖ at a moment tᵢ_{₂}, and generate an evaluation value vₐᵢ_{₂} for the commodity i₂, . . . , and by analogy, the user Uₐ may order a commodity iₙ from the supplier Sₖ at a moment tᵢ_{ₙ}, and generate an evaluation value vₐᵢ_{ₙ} for the commodity iₙ.

Based on the foregoing content, the following formula (1) may be used to calculate time adjustment factors in a time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> based on the time-dependent characteristic in the recommendation scenario and the network behavior occurrence time sequence <tᵢ_{₁}, tᵢ_{₂}, . . . , tᵢ_{ₙ}>.

$${δ}_{{i}_{j}} = \frac{\vert {T}_{now} - {t}_{{i}_{j}} \vert}{{T}_{period}} \qquad ( 1 )$$

In the formula (1), δᵢ_{ⱼ} represents a time adjustment factor corresponding to an evaluation value vₐᵢ_{ⱼ} in the commodity evaluation value sequence <vₐᵢ_{₁}, vₐᵢ_{₂}, . . . , vₐᵢ_{ₙ}>, 1≤j≤n, and j and n are natural numbers, T_{now} represents a current time, T_{period} represents a time period in the recommendation scenario, and is a preset value or an empirical value. For example, in a take-out order scenario, a value of the time period may be 5, 7, 10, 14, and tᵢ_{ⱼ} may represent a network behavior occurrence time corresponding to the evaluation value vₐᵢ_{ⱼ}.

Further, the following formula (2) may be used to multiply the commodity evaluation value sequence <vₐᵢ_{₁}, vₐᵢ_{₂}, . . . , vₐᵢ_{ₙ}> by the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> based on the time adjustment factors calculated by using the formula (1), to obtain an adjusted evaluation value of the user Uₐ corresponding to the supplier Sₖ in the user-supplier adjusted-evaluation matrix. The adjusted evaluation value of the user Uₐ corresponding to the supplier Sₖ is an adjusted evaluation value of the user Uₐ for the supplier Sₖ.

$${V}_{ak}^{′} = {\sum }_{j = 1}^{n} {δ}_{{ai}_{j}} {v}_{{ai}_{j}} \qquad ( 2 )$$

In the formula (2), v′ₐₖ represents the adjusted evaluation value of the user Uₐ corresponding to the supplier Sₖ. Relevant parts in the description of formula (1) may be referred to for explanations of other parameters, which are not repeatedly described herein.

Based on the foregoing process, each element value in the first user-supplier initial evaluation matrix may be adjusted based on the time-dependent characteristic in the recommendation scenario to obtain the user-supplier adjusted-evaluation matrix.

In this embodiment, the user-supplier adjusted-evaluation matrix may be constructed offline, so that the adjusted evaluation value of the at least one user corresponding to the candidate supplier may be directly obtained during online recommendation, thereby improving online recommendation effectiveness.

Obviously, in addition to pre-constructing the user-supplier adjusted-evaluation matrix offline, and directly obtaining the adjusted evaluation value of the at least one user corresponding to the candidate supplier during online recommendation, the adjusted evaluation value of the at least one user corresponding to the candidate supplier may be calculated in real time during online recommendation, and then a supplier may be recommended to a to-be-recommended user on such a basis.

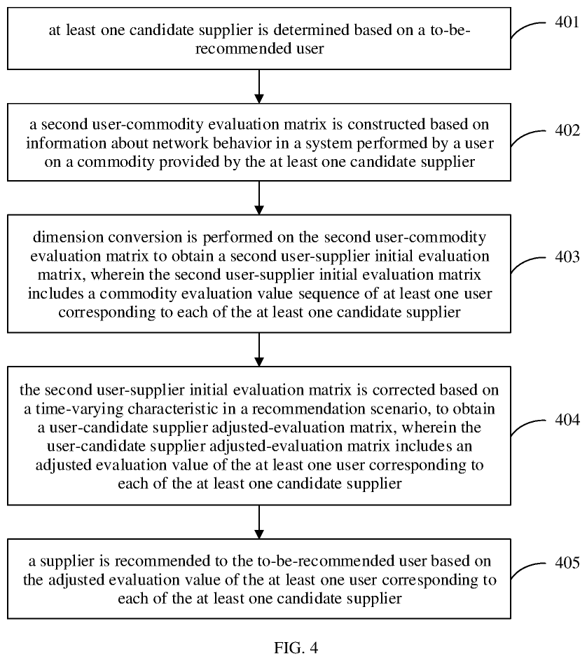

FIG. 4 is a schematic flowchart of a recommendation method according to still another embodiment of this disclosure. As shown in FIG. 4, the method includes the following steps.

In step 401, at least one candidate supplier may be determined based on a to-be-recommended user.

In step 402, a second user-commodity evaluation matrix may be constructed based on information about network behavior in a system performed by a user on a commodity provided by the at least one candidate supplier.

In step 403, dimension conversion may be performed on the second user-commodity evaluation matrix to obtain a second user-supplier initial evaluation matrix. The second user-supplier initial evaluation matrix may include a commodity evaluation value sequence of at least one user corresponding to each of at least one candidate supplier.

In step 404, the second user-supplier initial evaluation matrix may be adjusted based on a time-dependent characteristic in a recommendation scenario to obtain a user-candidate supplier adjusted-evaluation matrix. The user-candidate supplier adjusted-evaluation matrix may include an adjusted evaluation value of the at least one user corresponding to each of the at least one candidate supplier.

In step 405, a supplier may be recommended to the to-be-recommended user based on the adjusted evaluation value of the at least one user corresponding to each of the at least one candidate supplier.

Relevant parts in the description of the corresponding step in the foregoing embodiment may be referred to for details of step 401, which are not repeatedly described herein.

Steps 402 to 404 may be used for a process of generating the adjusted evaluation value of the at least one user corresponding to each of the at least one candidate supplier in real time, and the process may be similar to the process of pre-constructing a user-supplier adjusted-evaluation matrix, shown in FIG. 3a, with a difference may exist in the data sets. Relevant parts of the description of the process of the embodiment shown in FIG. 3a may be referred to for a detailed process of steps 402 to 404, which are not repeatedly described herein.

After obtaining the adjusted evaluation value of the at least one user corresponding to each of the at least one candidate supplier, as shown in step 405, a supplier may be recommended to the to-be-recommended user based on the adjusted evaluation value of the at least one user corresponding to each of the at least one candidate supplier to improve a recommendation effect.

In the foregoing embodiment or the following embodiment, a supplier may be recommended to the to-be-recommended user based on the adjusted evaluation value of the at least one user corresponding to each of the at least one candidate supplier.

Optionally, a supplier may be recommended to the to-be-recommended user by using a user-based collaborative filtering algorithm based on the adjusted evaluation value of the at least one user corresponding to each of the at least one candidate supplier.

Optionally, a supplier may be recommended to the to-be-recommended user by using a supplier-based collaborative filtering algorithm based on the adjusted evaluation value of the at least one user corresponding to each of the at least one candidate supplier.

The foregoing recommendation process using the user-based collaborative filtering algorithm and the foregoing recommendation process using the supplier-based collaborative filtering algorithm are separately described in detail below by using different embodiments.

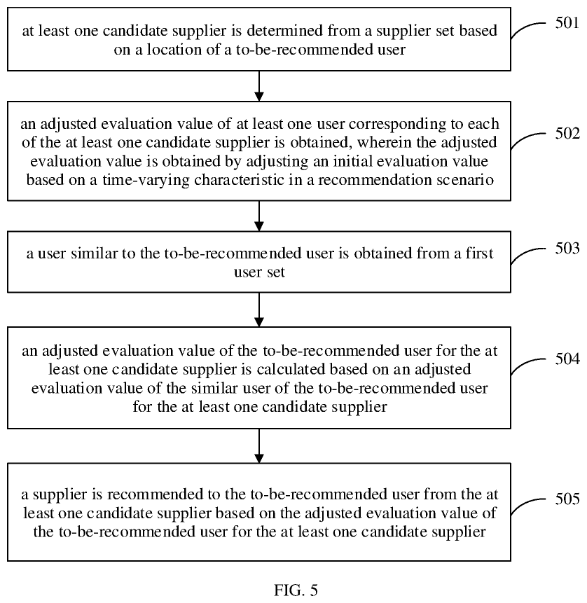

FIG. 5 is a schematic flowchart of a recommendation method according to still another embodiment of this disclosure. As shown in FIG. 5, the method includes the following steps.

In step 501, at least one candidate supplier may be determined from a supplier set based on a location of a to-be-recommended user.

In step 502, an adjusted evaluation value of at least one user corresponding to each of the at least one candidate supplier may be obtained. The adjusted evaluation value may be obtained by adjusting an initial evaluation value based on a time-dependent characteristic applicable to a recommendation scenario.

In this embodiment, relevant parts in the description for FIG. 2a and FIG. 3a, or the steps 402 to 404 in the embodiment shown in FIG. 4, may be referred to for detail implementation of step 502, which are not repeatedly described herein.

In step 503, a user similar to the to-be-recommended user may be obtained from a first user set.

Optionally, the first user set may include all users in a system, or may include some users in a system, or may include the at least one user corresponding to each of the at least one candidate supplier. In other words, one method to obtain a similar user is to obtain the user similar to the to-be-recommended user from all the users in the system. Another method to obtain a similar user is to obtain the user similar to the to-be-recommended user from some users in the system. Still another method to obtain a similar user is to obtain the user similar to the to-be-recommended user from the at least one user corresponding to each of the at least one candidate supplier.

Optionally, the user similar to the to-be-recommended user may be obtained from the first user set by using a cosine similarity calculation method or a Pearson (Pearson) similarity calculation method.

Optionally, a similarity between the to-be-recommended user and each user in the first user set may be calculated by using the Pearson similarity calculation method. The Pearson similarity calculation method has an advantage of relatively high similarity calculation precision. The to-be-recommended user may be denoted as uₐ, a user in the first user set may be denoted as u_{b}, and a Pearson similarity between uₐ and u_{b} may be calculated by using the following formula (3).

$${w}_{a , b} = \frac{{\sum }_{j = 1}^{M} ( {v}_{a , j} - {\overline{v}}_{a} ) ( {v}_{b , j} - {\overline{v}}_{b} )}{\sqrt{{\sum }_{j = 1}^{M} {( {v}_{a , j} - {\overline{v}}_{a} )}^{2} {\sum }_{j = 1}^{M} {( {v}_{b , j} - {\overline{v}}_{b} )}^{2}}} \qquad ( 3 )$$

In the formula (3), M represents a quantity of intersected suppliers between uₐ and u_{b}, the intersected supplier is an intersection between suppliers of uₐ and u_{b} (for example, a supplier evaluated by both uₐ and u_{b}), v_{a,j} represents an evaluation value of uₐ for a supplier sⱼ in the intersected suppliers, v̅ₐ represents an average evaluation value of uₐ, v_{b,j} represents an evaluation value of u_{b} for the supplier sⱼ, v̅_{b} represents an average evaluation value of u_{b}, and w_{a,b} represents a Pearson similarity between uₐ and u_{b}.

In the foregoing formula (3), the similarity between uₐ and u_{b} may be calculated based on only the intersected suppliers between uₐ and u_{b}. In an actual application, there may be a very small quantity of intersected suppliers. Therefore, the similarity calculated by using the foregoing formula (3) may be adjusted by using the following formula (4), to obtain an adjusted similarity.

$${w}_{a , b}^{′} = {w}_{a , b} \times \frac{M}{F} \qquad ( 4 )$$

In the formula (4), w′_{a,b} the adjusted similarity between uₐ and u_{b}, F represents a constant whose value may be determined based on a specific application scenario. For example, it may be, but is not limited to, 10.

$$\frac{M}{F}$$

is referred to as an impact factor, and

$$\frac{M}{F} = \{ \begin{matrix}1 & M \geq F \\ \frac{M}{F} & M < F\end{matrix} .$$

More specifically, when the quantity M of intersected suppliers between uₐ and u_{b} is greater than or equal to the constant F, it indicates that there are many intersected suppliers between uₐ and u_{b}, and there is no need to use the impact factor for adjustment. Therefore, a value of the impact factor is 1. Otherwise, when the quantity M of intersected suppliers between uₐ and u_{b} is less than the constant F, it indicates that there are a small quantity of intersected suppliers between uₐ and u_{b}, and the impact factor needs to be used for adjustment. Therefore, a value of the impact factor is less than 1. Accuracy and precision of a similarity calculation result can be improved by using the impact factor.

It can be learned that the similarity between the to-be-recommended user and each user in the first user set may be calculated based on the foregoing formulas (3) and (4), and the user similar to the to-be-recommended user may be further determined from the first user set based on the similarity between the to-be-recommended user and each user in the first user set. For example, at least one user with a highest similarity with the to-be-recommended user may be selected as a similar user of the to-be-recommended user. For another example, at least one user whose similarity with the to-be-recommended user is greater than a specified threshold may be selected as a similar user of the to-be-recommended user.

In step 504, an adjusted evaluation value of the to-be-recommended user for the at least one candidate supplier may be calculated based on an adjusted evaluation value of the similar user of the to-be-recommended user for the at least one candidate supplier.

Optionally, the adjusted evaluation value for each candidate supplier in the at least one candidate supplier may be calculated based on the following formula (5).

$${p}_{a , i} = {\overline{v}}_{a} + \frac{{\sum }_{c ∈ {U}^{′}} ( {v}_{c , i} - {\overline{v}}_{c} ) \times {w}_{a , c}^{′}}{{\sum }_{c ∈ {U}^{′}} {w}_{a , c}^{′}} \qquad ( 5 )$$

P_{a,i} represents an adjusted evaluation value of a to-be-recommended user uₐ for a candidate supplier sᵢ in the at least one candidate supplier, sᵢ∈S and S represents a candidate supplier set formed by the at least one candidate supplier. U′ represents a similar user set formed by users similar to the to-be-recommended user, w′_{a,c} represents an adjusted similarity between the to-be-recommended user uₐ and a similar user u_{c} in the similar user set, v_{c,i} represents an adjusted evaluation value of the similar user u_{c} in the similar user set for the candidate supplier sᵢ in the at least one candidate supplier, and v̅_{c} represents an average evaluation value of the similar user u_{c} in the similar user set.

For example, it is assumed that an adjusted evaluation value of a user for a candidate supplier may range from 0 to 5, which may respectively indicate degrees of preference in ascending order. It may be assumed that an adjusted evaluation value of a to-be-recommended user User5 for a candidate supplier Supplier_5 needs to be calculated based on adjusted evaluation values of User1 to User5, shown in Table 1, for candidate suppliers Supplier_1 to Supplier_6.

Based on Table 1, users most similar to User5 are sequentially User3, User4, User2 and User1 in descending order, and the adjusted evaluation value of User5 for Supplier_5 can be calculated by using adjusted evaluation values of these similar users for Supplier_5. As shown in a column of Supplier_5, the similar users all have a relatively good evaluation on Supplier_5. Therefore, User5 will also have a good evaluation on Supplier_5.

TABLE 1

| | Supplier_1 | Supplier_2 | Supplier_3 | Supplier_4 | Supplier_5 | Supplier_6 |
|---|---|---|---|---|---|---|
| User1 | 3 | 2 | | 4 | 5 | 2 |
| User2 | | 2 | 4 | 3 | 4 | |
| User3 | 3 | 1 | 3 | 3 | 3 | 2 |
| User4 | | | 3 | 3 | 4 | |
| User5 | 2 | | 3 | 3 | ? | |

The similar users of User5 may be found by using the foregoing formulas (3) and (4), and the adjusted evaluation value of User5 for Supplier_5 may be calculated based on the foregoing formula (5).

In step 505, a supplier may be recommended to the to-be-recommended user from the at least one candidate supplier based on the adjusted evaluation value of the to-be-recommended user for the at least one candidate supplier.

Optionally, at least one candidate supplier with a largest adjusted evaluation value may be selected and recommended to the to-be-recommended user. Alternatively, at least one candidate supplier whose adjusted evaluation value is greater than a specified threshold may be selected and recommended to the to-be-recommended user.

In this embodiment, impact of a time factor is considered, the initial evaluation value of the user for the commodity is adjusted based on the time-dependent characteristic applicable to the recommendation scenario, and a recommendation is provided based on the adjusted evaluation value. By considering the time factor in a recommendation process, the effectiveness of the recommendation may be improved. In addition, in this embodiment, the user-based collaborative filtering algorithm may be used to recommend a supplier by using a similarity between users, which provides a high prediction precision. In addition, the recommendation can vary with data, and is suitable for a system in which data is frequently updated.

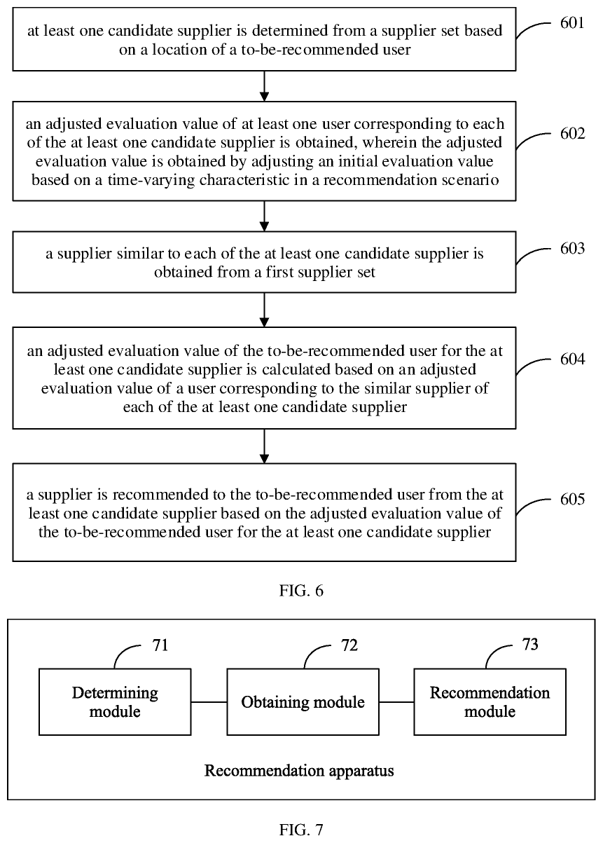

FIG. 6 is a schematic flowchart of a recommendation method according to still another embodiment of this disclosure. As shown in FIG. 6, the method may include the following steps.

In step 601, at least one candidate supplier may be determined from a supplier set based on a location of a to-be-recommended user.

In step 602, an adjusted evaluation value of at least one user corresponding to each of the at least one candidate supplier may be obtained. The adjusted evaluation value may be obtained by adjusting an initial evaluation value based on a time-dependent characteristic in a recommendation scenario.

In step 603, a supplier similar to each of the at least one candidate supplier may be obtained from a first supplier set.

Optionally, at least one candidate supplier with a largest adjusted evaluation value may be selected and recommended to the to-be-recommended user. Alternatively, at least one candidate supplier whose adjusted evaluation value is greater than a specified threshold may be selected and recommended to the to-be-recommended user.

Optionally, the first supplier set may include the at least one candidate supplier, or may include all suppliers in a system, or may include some suppliers in a system. In other words, one method to obtain a similar supplier may include obtaining the supplier similar to each of the at least one candidate supplier from the at least one candidate supplier. Another method to obtain a similar supplier is to obtain the supplier similar to each of the at least one candidate supplier from all the suppliers in the system. Still another method to obtain a similar supplier is to obtain the user similar to each of the at least one candidate supplier from some suppliers in the system.

Optionally, the supplier similar to each candidate supplier may be obtained from the first supplier set by using a cosine similarity calculation method or a Pearson similarity calculation method.

It should be noted that a process of calculating a similarity between each candidate supplier and each supplier in the first supplier set by using the cosine similarity calculation method or the Pearson similarity calculation method may be similar to the process of calculating a similarity between users based on the foregoing formula (3) and formula (4). A difference may be in that user-related parameters in the formula (3) and the formula (4) need to be replaced with related parameters of suppliers in the candidate suppliers and the first supplier set. A specific calculation process is not described herein.

In step 604, an adjusted evaluation value of the to-be-recommended user for the at least one candidate supplier may be calculated based on an adjusted evaluation value of a user corresponding to the similar supplier of each of the at least one candidate supplier.

In step 605, a supplier may be recommended to the to-be-recommended user from the at least one candidate supplier based on the adjusted evaluation value of the to-be-recommended user for the at least one candidate supplier.

In this embodiment, impact of a time factor is considered, the initial evaluation value of the user for the commodity is adjusted based on the time-dependent characteristic applicable to the recommendation scenario, and a recommendation is provided based on the adjusted evaluation value. By considering the time factor in a recommendation process, the effectiveness of the recommendation may be improved. In addition, in this embodiment, the supplier-based collaborative filtering algorithm may be used to recommend a supplier by using a similarity between suppliers, so that problems related to sparse data can be resolved, thereby improving the recommendation precision.

It should be noted that the steps in the method provided in the foregoing embodiment may be performed by one device, or by different devices. For example, step 101 to step 103 may be performed by a device A. For another example, step 101 and step 102 may be performed by a device A, and step 103 may be performed by a device B.

FIG. 7 is a schematic structural diagram of a recommendation apparatus according to still another embodiment of this disclosure. As shown in FIG. 7, the recommendation apparatus may include: a determining module 71, an obtaining module 72, and a recommendation module 73.

The determining module 71 may be configured to determine at least one candidate supplier based on a to-be-recommended user.

The obtaining module 72 may be configured to obtain an adjusted evaluation value of at least one user corresponding to each of the at least one candidate supplier. The adjusted evaluation value may be obtained by adjusting an initial evaluation value based on a time-dependent characteristic in a recommendation scenario.

The recommendation module 73 may be configured to recommend a supplier to the to-be-recommended user based on the adjusted evaluation value of the at least one user corresponding to each of the at least one candidate supplier.

In an optional implementation, the obtaining module 72 may be specifically configured to: obtain, from a pre-constructed user-supplier adjusted-evaluation matrix, the adjusted evaluation value of the at least one user corresponding to each of the at least one candidate supplier. The user-supplier adjusted-evaluation matrix may include an adjusted evaluation value of at least one user corresponding to each of a plurality of suppliers in a system, and the plurality of suppliers may include the at least one candidate supplier.

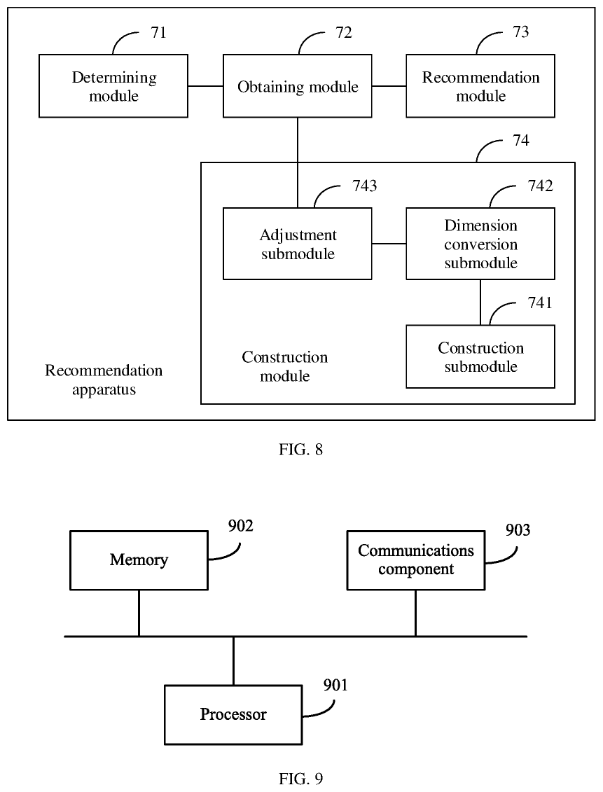

In an optional implementation, as shown in FIG. 8, the recommendation apparatus may further include a construction module 74, configured to pre-construct the user-supplier adjusted-evaluation matrix.

As shown in FIG. 8, an implementation structure of the construction module 74 may include a construction submodule 741, a dimension conversion submodule 742, and an adjustment submodule 743.

The construction submodule 741 may be configured to construct a first user-commodity evaluation matrix based on information about network behavior in the system performed by a user on a commodity.

The dimension conversion submodule 742 may be configured to perform dimension conversion on the first user-commodity evaluation matrix to obtain a first user-supplier initial evaluation matrix. The first user-supplier initial evaluation matrix may include a commodity evaluation value sequence of the at least one user corresponding to each of the plurality of suppliers.

The adjustment submodule 743 may be configured to adjust the first user-supplier initial evaluation matrix based on the time-dependent characteristic in the recommendation scenario to obtain the user-supplier adjusted-evaluation matrix.

In an optional implementation, the adjustment submodule 743 may be specifically configured to: calculate a time adjustment factor sequence corresponding to each commodity evaluation value sequence in the first user-supplier initial evaluation matrix based on the time-dependent characteristic in the recommendation scenario and a network behavior occurrence time sequence corresponding to each commodity evaluation value sequence in the first user-supplier initial evaluation matrix; and multiply each commodity evaluation value sequence in the first user-supplier initial evaluation matrix by the corresponding time adjustment factor sequence, to obtain the user-supplier adjusted-evaluation matrix.

In an optional implementation, the time-dependent characteristic in the recommendation scenario may be a characteristic that positive impact of a time factor on a recommendation process increases with time.

In an optional implementation, for a commodity evaluation value sequence <vₐᵢ_{₁}, vₐᵢ_{₂}, . . . , vₐᵢ_{ₙ}> of a user Uₐ corresponding to a supplier Sₖ in the first user-supplier initial evaluation matrix, a network behavior occurrence time sequence corresponding to the commodity evaluation value sequence <vₐᵢ_{₁}, vₐᵢ_{₂}, . . . , vₐᵢ_{ₙ}> is <tᵢ_{₁}, tᵢ_{₂}, . . . , tᵢ_{ₙ}>. The adjustment submodule 743 may specifically calculate a time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> based on the foregoing formula (1).

In an optional implementation, the adjustment submodule 743 may specifically multiply, based on the foregoing formula (2), the commodity evaluation value sequence <vₐᵢ_{₁}, vₐᵢ_{₂}, . . . , vₐᵢ_{ₙ}> by the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> to obtain an adjusted evaluation value of the user Uₐ corresponding to the supplier Sₖ in the user-supplier adjusted-evaluation matrix.

Relevant parts in the foregoing method embodiments may be referred to for detail explanation of parameters in formula (1) and formula (2), which are not repeatedly described herein.

In an optional implementation, the obtaining module 72 may be specifically configured to: construct a second user-commodity evaluation matrix based on information about network behavior in a system performed by a user on a commodity provided by the at least one candidate supplier; perform dimension conversion on the second user-commodity evaluation matrix to obtain a second user-supplier initial evaluation matrix, where the second user-supplier initial evaluation matrix includes a commodity evaluation value sequence of the at least one user corresponding to each of the at least one candidate supplier; and adjust the second user-supplier initial evaluation matrix based on the time-dependent characteristic in the recommendation scenario, to obtain a user-candidate supplier adjusted-evaluation matrix, where the user-candidate supplier adjusted-evaluation matrix includes the adjusted evaluation value of the at least one user corresponding to each of the at least one candidate supplier.

In an optional implementation, the recommendation module 73 may be specifically configured to: recommend a supplier to the to-be-recommended user by using a user-based collaborative filtering algorithm based on the adjusted evaluation value of the at least one user corresponding to each of the at least one candidate supplier; or recommend a supplier to the to-be-recommended user by using a supplier-based collaborative filtering algorithm based on the adjusted evaluation value of the at least one user corresponding to each of the at least one candidate supplier.

In an optional implementation, the determining module 71 may be specifically configured to obtain the at least one candidate supplier from a supplier set based on a location of the to-be-recommended user.

The recommendation apparatus provided in this embodiment of this disclosure may be configured to perform the procedure provided in the foregoing method embodiment, and a specific working principle thereof is not further described for the sake of conciseness.

According to the recommendation apparatus provided in this embodiment, impact of the time factor is considered in the recommendation process, the initial evaluation value of the user for the commodity is adjusted based on the time-dependent characteristic applicable to the recommendation scenario, and a recommendation is provided based on the adjusted evaluation value. By considering the time factor in the recommendation process, the effectiveness of the recommendation may be improved.

A person skilled in the art should understand that the embodiments of this disclosure may be provided as a method, a system, or a computer program product. Therefore, this disclosure may use a form of hardware only embodiments, software only embodiments, or embodiments with a combination of software and hardware. Moreover, this disclosure may use a form of a computer program product that is implemented on one or more computer-usable storage media (including but not limited to a disk memory, a CD-ROM, and an optical memory) that include computer-usable program code.

This disclosure is described with reference to the flowcharts and/or block diagrams of the method, the device (system), and the computer program product according to the embodiments of this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, an electronic device includes one or more central processing units (CPU), an input/output interface, a network interface, and a memory.

The memory may include a non-persistent memory, a random access memory (RAM), a non-volatile memory, and/or another form in a computer readable medium, for example, a read-only memory (ROM) or a flash memory (flash memory). The memory is an example of the computer readable medium.

As shown in FIG. 9, the electronic device may include at least one processor 901, a memory 902 in communication connection with the at least one processor 901, and a communications component 903 in communication connection with a scanning apparatus. The communications component 903 may receive and send data under control of the processor 901. The memory 902 may store a computer program instruction to be executed by the at least one processor 901, and the computer program instruction may be executed by the at least one processor 901 to perform the recommendation method in any foregoing embodiment.

Specifically, the processor 901 and the memory 902 may be connected using a bus or other method or device. Connection using a bus is an example shown in FIG. 9. The memory 902 may be a non-volatile computer readable storage medium, and may be configured to store a non-volatile software program, computer executable program, and module. The processor 901 may run the non-volatile software program, instruction, and module that are stored in the memory 902, to execute various function applications and data processing of the device (e.g., to perform the foregoing recommendation method).

The memory 902 may include a program storage area and a data storage area. The program storage area may store an operating system, and an application program required by at least one function. The data storage area may store an option list. In addition, the memory 902 may include a high-speed random access memory, and may further include a non-volatile memory, for example, at least one magnetic disk storage device, a flash storage device, or another non-volatile solid-state storage device. In some implementations, optionally, the memory 902 may include a storage remotely disposed relative to the processor 901. The remote storage may be connected to an external device through a network. An example of the network may include but is not limited to the Internet, an enterprise internal network, a local area network, a mobile communications network, and a combination thereof.

One or more modules may be stored in the memory 902. When the one or more modules are executed by the at least one processor 901, the recommendation method in any foregoing method implementation may be performed.

The computer readable medium includes persistent, non-persistent, movable, and unmovable media that may store information by using any method or technology. The information may be a computer readable instruction, a data structure, a program module, or other data. The computer readable medium, for example, includes but is not limited to: a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette, a magnetic tape, a magnetic disk storage or another magnetic storage device, or any other non-transmission medium that may be configured to store information accessible to the electronic device. Defined in this specification, the computer readable medium does not include transitory computer readable media (transitory media) such as a modulated data signal and carrier.

It should be further noted that the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to the process, method, article, or device. An element preceded by “includes a . . . ” does not, without more constraints, preclude the existence of additional identical elements in the process, method, article, or device that includes the element.

The foregoing descriptions are merely the embodiments of this disclosure, but are not intended to limit this disclosure. For a person skilled in the art, various medications and changes can be made to this disclosure. Any modification, equivalent replacement, or improvement made without departing from the spirit and principle of this disclosure shall fall within the claims of this disclosure.

What is claimed is:

1. A recommendation method, comprising:
determining, based on a to-be-recommended user, at least one candidate supplier;
obtaining an adjusted evaluation value of at least one user corresponding to each of the at least one candidate supplier, wherein the adjusted evaluation value is obtained by adjusting an initial evaluation value based on a time-dependent characteristic in a recommendation scenario, and wherein the time-dependent characteristic in the recommendation scenario is a characteristic that positive impact of a time factor on a recommendation process increases with time; and
recommending, based on the adjusted evaluation value of the at least one user corresponding to each of the at least one candidate supplier, a supplier to the to-be-recommended user,
wherein obtaining an adjusted evaluation value of at least one user corresponding to each of the at least one candidate supplier comprises:
multiplying each commodity evaluation value sequence in a first user-supplier initial evaluation matrix by a corresponding time adjustment factor sequence to pre-construct a user-supplier adjusted-evaluation matrix, wherein, in each commodity evaluation value sequence, a time adjustment factor corresponding to a commodity evaluation value is a ratio of an absolute time difference between a current time and a network behavior occurrence time corresponding to the evaluation value to a time period in the recommendation scenario; and
obtaining, from the pre-constructed user-supplier adjusted-evaluation matrix, the adjusted evaluation value of the at least one user corresponding to each of the at least one candidate supplier.

2. The method of claim 1, wherein the user-supplier adjusted-evaluation matrix comprises an adjusted evaluation value of at least one user corresponding to each of a plurality of suppliers in a system, and the plurality of suppliers comprise the at least one candidate supplier.

3. The method of claim 2, wherein pre-constructing the user-supplier adjusted-evaluation matrix comprises:
constructing, based on information about network behavior in the system performed by a user on a commodity, a first user-commodity evaluation matrix;
performing dimension conversion on the first user-commodity evaluation matrix to obtain a first user-supplier initial evaluation matrix, wherein the first user-supplier initial evaluation matrix comprises a commodity evaluation value sequence of the at least one user corresponding to each of the plurality of suppliers; and
multiplying each commodity evaluation value sequence in the first user-supplier initial evaluation matrix by the corresponding time adjustment factor sequence to pre-construct the user-supplier adjusted-evaluation matrix.

4. The method of claim 3, wherein for a commodity evaluation value sequence <vₐᵢ_{₁}, vₐᵢ_{₂}, . . . , vₐᵢ_{ₙ}> of a user Uₐ corresponding to a supplier Sₖ in the first user-supplier initial evaluation matrix, a network behavior occurrence time sequence corresponding to the commodity evaluation value sequence <vₐᵢ_{₁}, vₐᵢ_{₂}, . . . , vₐᵢ_{ₙ}> is <tᵢ_{₁}, tᵢ_{₂}, . . . , tᵢ_{ₙ}>,
and wherein the calculating, based on the time-dependent characteristic in the recommendation scenario and a network behavior occurrence time sequence <tᵢ_{₁}, tᵢ_{₂}, . . . , tᵢ_{ₙ}> corresponding to each commodity evaluation value sequence in the first user-supplier initial evaluation matrix, a time adjustment factor sequence <δₐᵢ_{₁}, δₐᵢ_{₂}, . . . , δₐᵢ_{ₙ}> corresponding to each commodity evaluation value sequence <vₐᵢ_{₁}, vₐᵢ_{₂}, . . . , vₐᵢ_{ₙ}> in the first user-supplier initial evaluation matrix comprises:
calculating, based on a formula
$${δ}_{{ai}_{j}} = \frac{\vert {T}_{now} - {t}_{{i}_{j}} \vert}{{T}_{period}} ,$$
time adjustment factors in the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}>, wherein
δₐᵢ_{ⱼ} represents a time adjustment factor corresponding to an evaluation value vₐᵢ_{ⱼ} in the commodity evaluation value sequence <vₐᵢ_{₁}, vₐᵢ_{₂}, . . . , vₐᵢ_{ₙ}>, 1≤j≤n, and j and n are natural numbers,
T_{now} represents a current time,
T_{period} represents a time period in the recommendation scenario, and
tᵢ_{ⱼ} represents a network behavior occurrence time corresponding to the evaluation value vₐᵢ_{ⱼ}.

5. The method of claim 4, wherein a commodity evaluation value sequence <vₐᵢ_{₁}, vₐᵢ_{₂}, . . . , vₐᵢ_{ₙ}> is multiplied by a time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}> to obtain an adjusted evaluation value of the user Uₐ corresponding to the supplier Sₖ in the user-supplier adjusted-evaluation matrix, wherein this step comprises:
calculating, based on a formula of
$${V}_{ak}^{′} = {\sum }_{j = 1}^{n} {δ}_{{ai}_{j}} {v}_{{ai}_{j}} ,$$
the adjusted evaluation value of the user Uₐ corresponding to the supplier Sₖ, wherein
v′ₐₖ represents the adjusted evaluation value of the user Uₐ corresponding to the supplier Sₖ.

6. The method of claim 1, wherein the obtaining an adjusted evaluation value of at least one user corresponding to each of the at least one candidate supplier comprises:
constructing, based on information about network behavior in a system performed by a user on a commodity provided by the at least one candidate supplier, a second user-commodity evaluation matrix;
performing dimension conversion on the second user-commodity evaluation matrix to obtain a second user-supplier initial evaluation matrix, wherein the second user-supplier initial evaluation matrix comprises a commodity evaluation value sequence of the at least one user corresponding to each of the at least one candidate supplier; and
adjusting the second user-supplier initial evaluation matrix based on the time-dependent characteristic in the recommendation scenario, to obtain a user-candidate supplier adjusted-evaluation matrix, wherein the user-candidate supplier adjusted-evaluation matrix comprises the adjusted evaluation value of the at least one user corresponding to each of the at least one candidate supplier.

7. The method of claim 1, wherein the recommending, based on the adjusted evaluation value of the at least one user corresponding to each of the at least one candidate supplier, a supplier to the to-be-recommended user comprises:
recommending a supplier to the to-be-recommended user by using a user-based collaborative filtering algorithm based on the adjusted evaluation value of the at least one user corresponding to each of the at least one candidate supplier; or
recommending a supplier to the to-be-recommended user by using a supplier-based collaborative filtering algorithm based on the adjusted evaluation value of the at least one user corresponding to each of the at least one candidate supplier.

8. The method of claim 1, wherein the determining, based on a to-be-recommended user, at least one candidate supplier comprises:
obtaining, based on a location of the to-be-recommended user, the at least one candidate supplier from a supplier set.

9. A recommendation apparatus, comprising:
a determining module, configured to determine, based on a to-be-recommended user, at least one candidate supplier;
an obtaining module, configured to obtain an adjusted evaluation value of at least one user corresponding to each of the at least one candidate supplier, wherein the adjusted evaluation value is obtained by adjusting an initial evaluation value based on a time-dependent characteristic in a recommendation scenario, wherein the time-dependent characteristic in the recommendation scenario is a characteristic that positive impact of a time factor on a recommendation process increases with time;
a recommendation module, configured to recommend, based on the adjusted evaluation value of the at least one user corresponding to each of the at least one candidate supplier, a supplier to the to-be-recommended user; and
a construction module, configured to multiply each commodity evaluation value sequence in a first user-supplier initial evaluation matrix by a corresponding time adjustment factor sequence to pre-construct a user-supplier adjusted-evaluation matrix, wherein, in each commodity evaluation value sequence, a time adjustment factor corresponding to a commodity evaluation value is a ratio of an absolute time difference between a current time and a network behavior occurrence time corresponding to the evaluation value to a time period in the recommendation scenario,
and wherein the obtaining module is specifically configured to obtain, from the pre-constructed user-supplier adjusted-evaluation matrix, the adjusted evaluation value of the at least one user corresponding to each of the at least one candidate supplier.

10. The apparatus of claim 9, wherein the user-supplier adjusted-evaluation matrix comprises an adjusted evaluation value of at least one user corresponding to each of a plurality of suppliers in a system, and the plurality of suppliers comprise the at least one candidate supplier.

11. The apparatus according to claim 10, wherein the construction module comprises:
a construction submodule, configured to construct, based on information about network behavior in the system performed by a user on a commodity, a first user-commodity evaluation matrix;
a dimension conversion submodule, configured to perform dimension conversion on the first user-commodity evaluation matrix to obtain a first user-supplier initial evaluation matrix, wherein the first user-supplier initial evaluation matrix comprises a commodity evaluation value sequence of the at least one user corresponding to each of the plurality of suppliers; and
an adjustment submodule, configured to multiply each commodity evaluation value sequence in the first user-supplier initial evaluation matrix by the corresponding time adjustment factor sequence to pre-construct the user-supplier adjusted-evaluation matrix.

12. The apparatus of claim 11, wherein for a commodity evaluation value sequence <vₐᵢ_{₁}, vₐᵢ_{₂}, . . . , vₐᵢ_{ₙ}> of a user Uₐ corresponding to a supplier Sₖ in the first user-supplier initial evaluation matrix, a network behavior occurrence time sequence corresponding to the commodity evaluation value sequence <vₐᵢ_{₁}, vₐᵢ_{₂}, . . . , vₐᵢ_{ₙ}>is <tᵢ_{₁}, tᵢ_{₂}, . . . , tᵢ_{ₙ}>,
and when calculating, based on the time-dependent characteristic in the recommendation scenario and the network behavior occurrence time sequence <tᵢ_{₁}, tᵢ_{₂}, . . . , tᵢ_{ₙ}>, a time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}>, the adjustment submodule is specifically configured to:
calculate, based on a formula
$${δ}_{{ai}_{j}} = \frac{\vert {T}_{now} - {t}_{{i}_{j}} \vert}{{T}_{period}} ,$$
time adjustment factors in the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}>, wherein
δₐᵢ_{ⱼ} represents a time adjustment factor corresponding to an evaluation value vₐᵢ_{ⱼ} in the commodity evaluation value sequence <vₐᵢ_{₁}, vₐᵢ_{₂}, . . . , vₐᵢ_{ₙ}>, 1≤j≤n, and j and n are natural numbers;
T_{now} represents a current time;
T_{period} represents a time period in the recommendation scenario; and
tᵢ_{ⱼ} represents a network behavior occurrence time corresponding to the evaluation value vₐᵢ_{ⱼ}.

13. The apparatus of claim 12, wherein when multiplying the commodity evaluation value sequence <vₐᵢ_{₁}, vₐᵢ_{₂}, . . . , vₐᵢ_{ₙ}> by the time adjustment factor sequence <δₐᵢ_{₁}, δₐᵢ_{₂}, . . . , δₐᵢ_{ₙ}> corresponding to the commodity evaluation value sequence <vₐᵢ_{₁}, vₐᵢ_{₂}, . . . , vₐᵢ_{ₙ}>, to obtain an adjusted evaluation value of the user Uₐ corresponding to the supplier Sₖ in the user-supplier adjusted-evaluation matrix, the adjustment submodule is specifically configured to:
calculate, based on a formula
$${V}_{ak}^{′} = {\sum }_{j = 1}^{n} {δ}_{{ai}_{j}} {v}_{{ai}_{j}} ,$$
the adjusted evaluation value of the user Uₐ corresponding to the supplier Sₖ, wherein
v′ₐₖ represents the adjusted evaluation value of the user Uₐ corresponding to the supplier Sₖ.

14. The apparatus of claim 9, wherein the obtaining module is specifically configured to:
construct, based on information about network behavior in a system performed by a user on a commodity provided by the at least one candidate supplier, a second user-commodity evaluation matrix;
perform dimension conversion on the second user-commodity evaluation matrix to obtain a second user-supplier initial evaluation matrix, wherein the second user-supplier initial evaluation matrix comprises a commodity evaluation value sequence of the at least one user corresponding to each of the at least one candidate supplier; and
adjust the second user-supplier initial evaluation matrix based on the time-dependent characteristic in the recommendation scenario, to obtain a user-candidate supplier adjusted-evaluation matrix, wherein the user-candidate supplier adjusted-evaluation matrix comprises the adjusted evaluation value of the at least one user corresponding to each of the at least one candidate supplier.

15. The apparatus of claim 9, wherein the recommendation module is specifically configured to:
recommend a supplier to the to-be-recommended user by using a user-based collaborative filtering algorithm based on the adjusted evaluation value of the at least one user corresponding to each of the at least one candidate supplier; or
recommend a supplier to the to-be-recommended user by using a supplier-based collaborative filtering algorithm based on the adjusted evaluation value of the at least one user corresponding to each of the at least one candidate supplier.

16. The apparatus of claim 9, wherein the determining module is specifically configured to:
obtain, based on a location of the to-be-recommended user, the at least one candidate supplier from a supplier set.

17. An electronic device, comprising a memory and a processor, wherein the memory is configured to store one or more computer instructions, and the one or more computer instructions are executed by the processor to perform the method of claim 1.

18. A computer readable storage medium storing a computer program, wherein the computer program enables a computer to perform the method of claim 1.
